(19) United States
(12) Patent Application Publication
(10) Pub. No.: US 2008/0190021 A1
(43) Pub. Date: Aug. 14, 2008

(54) Waterproof plant pot holder

(76) Inventor: Merri Lee Marks, Los Angeles, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 11/706,042

(22) Filed: Feb. 13, 2007

(51) Int. Cl. A01G 9/02

(52) U.S. Cl. 47/65.8

(57) ABSTRACT

A decorative plant pot holder including a substantially waterproof plant pot sleeve and a decorative plant pot fabric covering. The waterproof plant pot sleeve may be affixed to a plant pot using one or more zippers oriented to close around the sides of the plant pot. The zippers may end some predetermined distance above the bottom of the plant pot so as to minimize the possibility of water leakage through the zipper mechanism.

### FIELD OF THE INVENTION

The invention relates in general to plant pot holders and, more particularly to a waterproof plant pot sleeve usable in conjunction with decorative plant pot sleeves.

### BACKGROUND

Plant pots have been manufactured to be both water proof and decorative. In many cases, it is desirable to attempt to match the appearance of a plant pot to its surroundings. In the case of house plants, home owners may find it very difficult to find a plant pot which matches their furniture upholstery, wall colors and/or general room appearance. While plant pots are manufactured in a host of solid colors and even a few patterns, it is not cost effective for manufacturers to produce plant pots in a multitude of decorative designs.

One possible way to match the appearance of a plant pot to its surroundings has been to cover the plant pot with a patterned fabric cover. However, this approach has had a significant drawback caused by the fact that pots are typically designed with holes to protect the plant from over watering. Thus, plant pots tend to routinely leak water and, hence, would tend to damage such fabric coverings. Thus, there is a need for waterproof plant pot holder which enables decorative fabric covers to be used without being exposed to water damage.

### SUMMARY OF THE INVENTION

A decorative plant pot holder is disclosed and claimed. In one embodiment, a decorative plant pot holder includes a substantially waterproof sleeve configured to accommodate a plant pot therein, wherein the sleeve includes at least one zipper oriented to close and secure itself around a plant pot when zipped. The decorative plant pot holder further includes a decorative sleeve configured to fit over the substantially waterproof sleeve where the waterproof sleeve can be used to insulate the decorative sleeve from plant pot water leakage.

Other embodiments are disclosed and claimed herein.

### BRIEF DESCRIPTION OF THE DRAWINGS

FIG. 1 depicts one embodiment of a waterproof plant pot sleeve in accordance with the principles of the invention;

FIG. 2 depicts another embodiment of the waterproof plant pot sleeve of FIG. 1 fitted over a plant pot;

FIG. 3 depicts one embodiment of how a plant pot, waterproof sleeve and decorative covering may be assembled in accordance with the principles of the invention; and

FIG. 4 depicts another embodiment of the waterproof plant pot sleeve of FIG.

### DETAILED DESCRIPTION OF EXEMPLARY EMBODIMENTS

One aspect of the invention is to provide a waterproof plant pot sleeve which can be used in conjunction with a decorative plant pot fabric covering. In one embodiment, the waterproof plant pot sleeve is made of a flexible plastic and can be affixed to a plant pot using one or more zippers oriented to close around the sides of the plant pot. In another embodiment, the one or more zippers end some predetermined distance (e.g., 4 inches) above the bottom of the pot so as to minimize the possibility of water leakage through the zipper mechanism.

Another aspect of the invention is to provide a waterproof plant pot sleeve which can be used in conjunction with a decorative plant pot fabric covering, wherein the waterproof sleeve is comprised of a base portion and a top portion. In one embodiment, the base portion is stitched to the top portion a predetermined distance (e.g., 4 inches) above the base of the plant pot sleeve, and hence above the base of a pot which is to be placed within the substantially waterproof plant pot sleeve. In one embodiment, this is done to minimize the possibility of water leakage through the base portion stitching. Where one or more zippers are used to affix the plant pot holder to a pot, such zipper(s) may end some distance (e.g., 2 inches) above the base portion stitching so as to further minimize the leakage of water.

Still another aspect of the invention is to provide a decorative fabric covering which may be used to cover a plant pot and waterproof plant pot sleeve. In one embodiment, the decorative covering can be affixed to the plant pot and plant pot sleeve using one or more zippers oriented to close around the sides of the plant pot. In another embodiment, the aforementioned waterproof plant pot sleeve effectively keeps the decorative fabric covering from sustaining any water damage in the case of over watering.

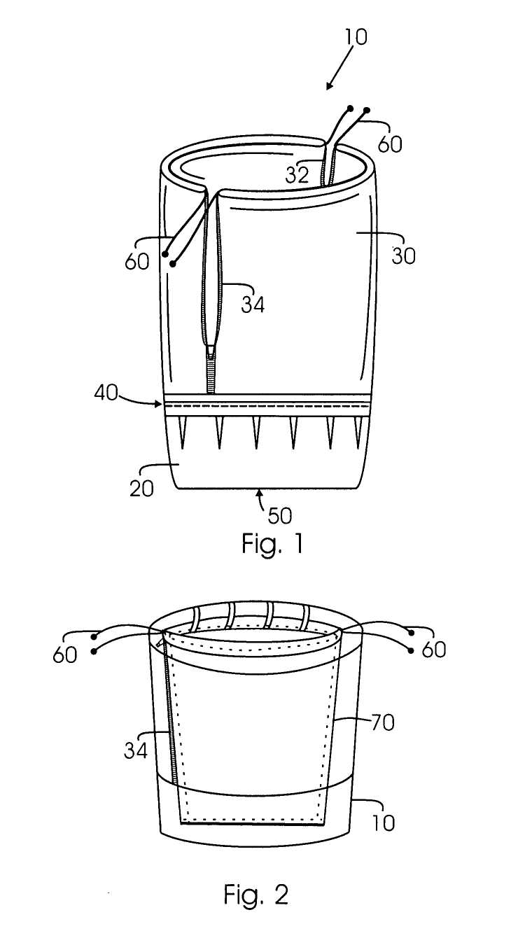

Referring now to the figures, FIG. 1 depicts one embodiment of a flexible substantially waterproof plant pot sleeve 10, comprised of a base portion 20 and a top portion 30. In one embodiment, the base portion 20 may be stitched to top portion 30 along a stitch line 40, as depicted in FIG. 1. Since stitch line 40 may not be substantially waterproof, it may be desirable to locate the stitch line some distance above the base of the plant pot holder 10. To that end, in the embodiment of FIG. 1 the stitch line 40 is shown as being 4 inches above the base 50 of the waterproof plant pot sleeve 10. However, it should equally be appreciated that the stitch line 40 may be higher or lower and still minimize the possibility of water leakage through the stitch line 40. For example, in another embodiment stitch line 40 may be about 1 inch above the base 50 of the plant pot sleeve 10.

Continuing to refer to FIG. 1, waterproof plant pot sleeve 10 is further depicted as having zippers 32 and 34 oriented approximately opposite to one another along the sides of top portion 30. In one embodiment, zippers 32 and 34 may be used to affix the plant pot sleeve 10 to a plant pot (not shown). By unzipping zippers 32 and 34, the waterproof plant pot sleeve 10 may easily be removed from around a plant pot (not shown). It should also equally be appreciated that only one zipper running along one side of top portion 30 may be used.

Since the zipper seams for zipper 32 and 34 may not be substantially waterproof, it may be desirable to end the zipper seam(s) some distance above the stitch line 40 and/or the base 50 of the plant pot sleeve 10. To that end, the zipper seam(s) is shown as ending about 2 inches above the stitch line 40 so as to further minimize the potential leakage of water. However, it should equally be appreciated that the zipper line(s) may be terminated higher or lower than that.

Substantially waterproof plant pot sleeve 10 may further be equipped with optional drawstrings 60 usable to secure the top of the top portion 60 (e.g., above the top of zippers 32 and 34).

FIG. 2 depicts the substantially waterproof plant pot sleeve 10 of FIG. 1 in a secured position around a plant pot 70. In this embodiment, the zippers 32 and 34 of waterproof plant pot sleeve 10 have been zipped up and the drawstrings 60 tied. Moreover, in this embodiment the height of the waterproof plant pot sleeve 10 is greater than the height of the plant pot 70 it is covering. In such a case, a top portion of the waterproof plant pot sleeve 10 may be folded in over the top edge of the plant pot, as shown in FIG. 2.

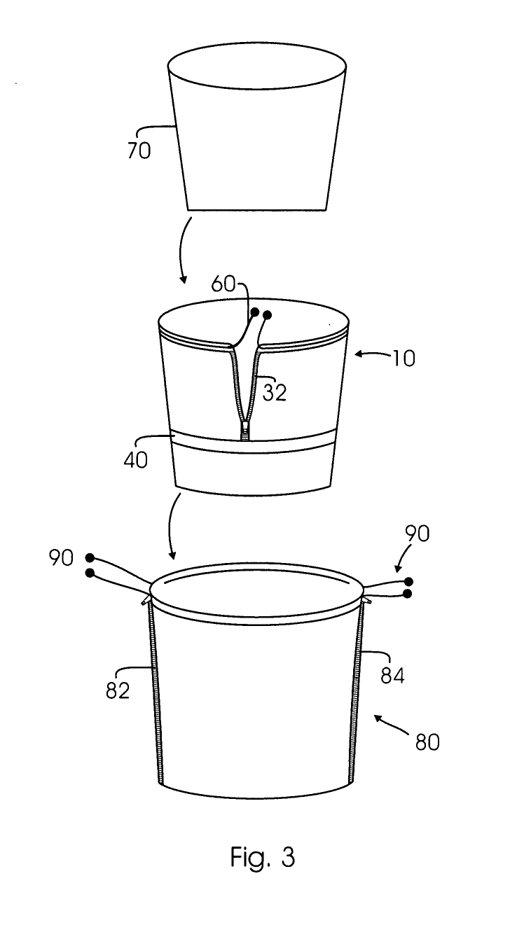

FIG. 3 depicts one embodiment of how a plant pot 70, waterproof plant pot sleeve 10 and decorative covering 80 may be assembled in accordance with the principles of the invention. In particular, plant pot 70 is shown as being placed within waterproof plant pot sleeve 10 while zipper 32 is unzipped and drawstrings 60 untied. At that point, the combination of the waterproof plant pot sleeve 10 and plant pot 70 may be fitted within decorative covering 80, as shown in FIG. 3. Moreover, decorative covering 80 may also be equipped with one or more zippers (e.g., zippers 82 and 84) and drawstrings 90. In another embodiment, decorative covering 80 may not have drawstrings and may have one or more zippers.

Continuing to refer to FIG. 3, in one embodiment the decorative covering 80 may be made of a fabric material which is substantially insulated from possible plant pot water leakage by said waterproof plant pot sleeve 10.

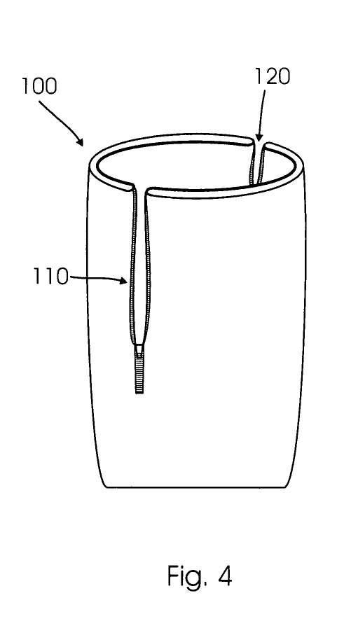

FIG. 4 is another embodiment of the substantially waterproof plant pot sleeve 10 of FIG. 1. In this embodiment, the waterproof plant pot sleeve 100 does not have a top portion and bottom portion connected by a stitch line. Rather, the waterproof plant pot sleeve 100 is designed as a single substantially waterproof piece which can be fitted to or removed from a plant pot using zippers 110 and 120. In one embodiment, the waterproof plant pot sleeve 100 may be used to keep a decorative fabric covering (e.g., decorative covering 80) from sustaining water damage from plant pot water leakage.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1-10. (canceled)

11. A substantially waterproof sleeve configured to accommodate a plant pot therein, wherein said substantially waterproof sleeve includes at least one zipper oriented to close and secure said substantially waterproof sleeve around the plant pot when zipped, and wherein said substantially waterproof sleeve is further configured to insulate a decorative sleeve from plant pot water leakage.

12. The substantially waterproof sleeve of claim 11, wherein said substantially waterproof sleeve is to be removable from said plant pot when said zipper is unzipped.

13. The substantially waterproof sleeve of claim 11, wherein said zipper extends from a top of said substantially waterproof sleeve to a point that above a bottom of said substantially waterproof sleeve.

14. The substantially waterproof sleeve of claim 13, wherein said point is at least 1 inch above the bottom of said substantially waterproof sleeve.

15. The substantially waterproof sleeve of claim 11, wherein said substantially waterproof sleeve is comprised of a bottom portion and a top portion, wherein said bottom portion is stitched to said top portion along a stitch line which is at least 1 inch above a base of said substantially waterproof sleeve.

16. The substantially waterproof sleeve of claim 15, wherein said zipper ends above said stitch line.

17. The substantially waterproof sleeve of claim 11, wherein said substantially waterproof sleeve includes one or more drawstrings usable to secure a portion of said substantially waterproof sleeve which is above said zipper.

18. (canceled)

19. The substantially waterproof sleeve of claim 11, wherein said substantially waterproof sleeve has two zippers oriented opposite each other usable to secure said substantially waterproof sleeve over said plant pot.

20. (canceled)
